(19) United States
(12) Patent Application Publication
(10) Pub. No.: US 2004/0225571 A1
(43) Pub. Date: Nov. 11, 2004

(54) Model for e-business scenario correlation

(76) Inventor: Prem S. Urali, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/430,552

(22) Filed: May 6, 2003

(51) Int. Cl. G06F 17/60

(52) U.S. Cl. 705/26; 705/1; 707/104.1

(57) ABSTRACT

A system and method for correlation of business documents in business scenario(s) is provided. The system facilitates retrieval of business documents (e.g., XML-based) from various database system(s), correlation of the retrieved business documents based, at least in part, one or more business scenario, and, presentation of the correlated business documents to a user.

Retrieval of business document from of data stores based, at least in part, upon retrieval criteria (e.g., key field(s)). Thereafter, a business model component correlates the retrieved business documents based, at least in part, upon a business scenario. An output based, at least in part, upon the correlated business documents can then be provided.

### TECHNICAL FIELD

The present invention relates generally to e-business transactions, and in particular to systems and methods to model e-business scenario correlation.

### BACKGROUND OF THE INVENTION

Electronic commerce (e.g., e-commerce and e-business) has evolutionalized business practices by providing an efficient, reliable and cost-effective medium for business transactions. This evolution has fueled a growing trend towards eliminating paper transactions and conducting a large volume of business electronically. Many businesses have already shifted paradigms and are conducting a substantial portion of their business via networks (e.g., the Internet, virtual private networks and/or an intranets).

One advantage of conducting e-business is that it provides a business with a capability to efficiently transmit and receive information from essentially anywhere and at any time. The impact of such accessibility has provided business relationships with markets that were once unavailable, world-wide visibility, increased competition within markets, quality improvements, “true” market driven prices, increased buyer/seller choice, decreased operational costs through mitigating overhead such as paper products, and diminished paper waste.

The robustness of e-business continues to progress with technological advances in the electrical/electronical and software fields. Such advances provide improved communication devices and improved user-friendly applications. In addition, the availability and affordability of computerized systems and e-business software that can be executed thereon facilitates a growing movement towards selling and purchasing goods via e-business. From the foregoing advances and trends, it has become foreseeable that the near future will demand business transactions to be conducted via e-business in order to compete within a business market.

A simple example of an e-business transaction includes a business-to-business purchase of goods. For example, a seller and a buyer can interface via a network (e.g., the Internet), wherein the seller can provide product information, including price. The buyer can submit an order to the seller for a quantity of goods as an e-business transaction. For example, the buyer can submit a purchase order via an c-business transaction instead of the conventional means of mailing a paper form. When the seller receives the e-business purchase order, the seller can process the order and reply with an e-business invoice.

Business activities can be described in terms of interaction scenario(s). An example of a simple interaction scenario is the process of visiting a supermarket, picking an item of interest and paying for the item at the checkout counter. This process has been completely automated as an e-business process.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Business process execution occurs in the context of business scenario(s). The business scenario execution(s) leave a trail of business documents. The present invention provides for systems and method for correlation of business documents in business scenario(s). The system facilitates retrieval of business documents (e.g., XML-based) from various database system(s), correlation of the retrieved business documents based, at least in part, one or more business scenario, and, presentation of the correlated business documents to a user.

Retrieval of business document from data stores is based, at least in part, upon retrieval criteria (e.g., key field(s)). Thereafter, a business model component correlates the retrieved business documents based, at least in part, upon a business scenario. An output based, at least in part, upon the correlated business documents can then be provided.

A business document can be designated as a root node document (e.g., during design-time). The root document begins the execution of a business scenario. For example, in the order-to-cash scenario, the arrival of an order document results initiates a new order-to-cash scenario. It is to be appreciated that a root document of one business scenario can be a leaf node document of a different business scenario.

The documents are related by key field(s) associated with the documents. A “key field” is a unique identifier of the document and/or by virtue of the document being a root node document, the business scenario. A composite key can become the unique identifier.

In accordance with an aspect of the present invention, the system can facilitate a tracking envelope for business documents. This facilitates isolation if the need for maintaining tracking information away from the business documents. For example, in the order-to-cash scenario, the time at which the order document was received by the e-business system. The envelope can store metadata associated with a business document, for example, creation date and/or time, creation actor, next modified date and/or time, next modified actor, last modified date and/or time, and/or, last modified actor.

Yet another aspect of the present invention provides for a developer at design-time to designate a business document as a root node (e.g., top level scenario transaction document) and/or as leaf node document. Top-level documents are associated with the initiation of the execution of an instance of a business scenario. Leaf-level node document(s) are created as a future step in the execution of a business scenario. For example, the designation can be implemented by way of specialized annotation to the XSD doc definition. A doc definition can be employed to designate a document as a root-node by way of annotation to the XSD of the document. Further, key field(s) within document(s) (root or leaf) can be annotated decoration of the corresponding XSDs.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of an e-business correlation system in accordance with an aspect of the present invention.

FIG. 2 is a diagram of an envelope in accordance with an aspect of the present invention.

FIG. 3 is a block diagram of an exemplary order-to-cash scenario in accordance with an aspect of the present invention.

FIG. 4 is a diagram of an exemplary purchase order envelope in accordance with an aspect of the present invention.

FIG. 5 is a diagram of an exemplary purchase order response envelope in accordance with an aspect of the present invention.

FIG. 6 is a diagram of an exemplary advance shipping notification envelope in accordance with an aspect of the present invention.

FIG. 7 is a diagram of an exemplary change order envelope in accordance with an aspect of the present invention.

FIG. 8 is a diagram of an exemplary invoice envelope in accordance with an aspect of the present invention.

FIG. 9 is a diagram of an exemplary remittance advice envelope accordance with an aspect of the present invention.

FIG. 10 is a diagram of an exemplary user interface in accordance with an aspect of the present invention.

FIG. 11 is a flow chart of a method of correlating e-business information 1100 in accordance with an aspect of the present invention.

FIG. 12 is a flow chart of a method of generating a business scenario for e-business in accordance with an aspect of the present invention.

FIG. 13 illustrates an example operating environment in which the present invention may function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the term “computer component” is intended to refer to a computer-related entity, either hardware, a combination of hardware and software, software, or software in execution. For example, a computer component may be, but is not limited to being, a process running on a processor, a processor, an object, an executable, a thread of execution, a program, and/or a computer. By way of illustration, both an application running on a server and the server can be a computer component. One or more computer components may reside within a process and/or thread of execution and a component may be localized on one computer and/or distributed between two or more computers.

An arbitrarily complex business can be represented as comprising a set of interconnected business scenario(s) that define a business scenario model. Typically, business scenarios involve multiple systems of records. For example, an enterprise, a plurality of system can exist that handle similar data. A customer entity can be modeled in an Enterprise Resource Planning (ERP) system and in a Customer Relationship Management (CRM) system. Maintenance of multiple system can lead to synchronization challenges, thus, generally businesses designate one system to be the system of record for a given information type.

Additionally, business scenarios typically involve large a large quantity of transactions that related to one another. Business activities in an enterprise flow from transaction to transaction. For example, the act of signing up for a long distance company and a particular calling plan can trigger multiple transactions (e.g., the initial account setup, the addition of a calling plan to the account and/or billing against the calling plan etc.) Generally, business transactions can be classified as “root node” transactions (e.g., the transaction that setup the initial account) or “leaf-node” transactions.

Depending on the level of granularity of interest to user(s), business scenarios can be described as top level (e.g., order taking and/or fulfillment of order) and/or lower level (e.g., return processing for merchandise returned within thirty days with a receipt). Generally, business entities have predefined process(es) for normal and/or customary business process(es). However, from time to time, business process(es) can be created on an ad hoc basis (e.g., a customer service manager making the call to reverse the finance charges on a delinquent account because of an extenuating circumstance that the customer described and was able to document).

In certain business environments, there is a need for strict enforcement of business rule(s) (e.g., a bank teller has to put hold on withdrawal of cash from an account that was just now funded with a check that has not cleared). Further, as business(es) evolve their business process(es) can correspondingly change. Thus there is a need for the lifetime management of the business process(es) and the associated scenario(s). Ad hoc processes also require change management. E-business scenario(s) can also involve authorization, access control, encryption and/or privacy requirement(s). Business scenario(s) can also involve document(s) that are out of order (e.g., a sub-process can be hidden from the view of the system and hence an unexpected document may arrive). Further, an error in a process somewhere can cause an out of sequence document to arrive.

Generally, a business scenario model can facilitate a user searching the set of business scenario(s) based, at least in part, upon search criteria. Thereafter, the user can drill down into details, as needed. Further, the user can move between related business scenario executions and/or track a trail of event(s) that comprise a particular business scenario. The systems and methods of the present invention provide a novel approach by which business documents can be stored in a database system (e.g., as a series of XML documents) that can then be correlated into business scenario execution(s).

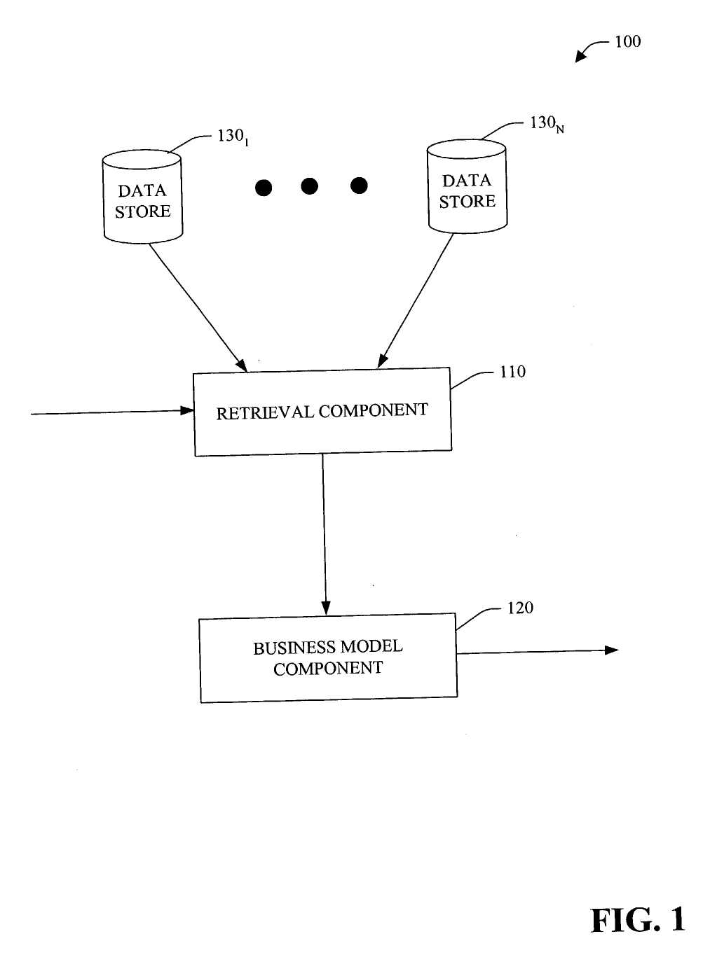

Referring to FIG. 1, an e-business correlation system 100 in accordance with an aspect of the present invention is illustrated. The system 100 facilitates retrieval of business documents from various database system(s), correlation of the retrieved business documents based, at least in part, one or more business scenario, and, presentation of the correlated business documents to a user (not shown). The system 100 includes a retrieval component 110 and a business model component 120.

The retrieval component 110 retrieves business document(s) from a plurality of data stores 130 based, at least in part, upon retrieval criteria (e.g., key field(s)). Thereafter, the business model component 120 correlates the retrieved business documents based, at least in part, upon a business scenario. The business model component 120 then provides an output based, at least in part, upon the correlated business documents.

Business process execution occurs in the context of business scenario(s). The business scenario execution(s) leave a trail of business documents. For example, in an order-to-cash scenario, a given execution can result in the following documents: purchase order, purchase order response, advance shipping notification, invoice and remittance advice.

A business document can be designated as a root document (e.g., during design-time). The root document begins the execution of a business scenario. For example, in the order-to-cash scenario, the arrival of an order document results initiates a new order-to-cash scenario. It is to be appreciated that a root document of one business scenario can be a leaf node of a different business scenario.

The documents are related by key field(s) associated with the documents. A “key field” is a unique identifier of the document and/or by virtue of the document being a root node document, the business scenario. A composite key can become the unique identifier. For example, in an order-to-cash scenario, a customer order identifier along with a customer name can be a unique way to tag a business scenario. In another example, an order identifier assigned by the business on acceptance of the order document from the trading partner can be the unique tag.

At design-time, certain key field(s) can be designated as searchable fields. Search capability is important when the system 100 is wading through a repository of document instances in order to recreate the business scenario for the user of the system 100. For example, in addition to the key field, there can be other field(s) that are interesting for the purposes of searching (e.g., date of placement of the order).

Additionally, the system 100 can facilitate a tracking envelope for business documents. This facilitates isolation if the need for maintaining tracking information away from the business documents. For example, in the order-to-cash scenario, the time at which the order document was received by the e-business system.

While FIG. 1 is a block diagram illustrating components for the e-business correlation system 100, it is to be appreciated that the e-business correlation system 100, the retrieval component 110 and/or the business model component 120 can be implemented as one or more computer components, as that term is defined herein. Thus, it is to be appreciated that computer executable components operable to implement the e-business correlation system 100, the retrieval component 110 and/or the business model component 120 can be stored on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the present invention.

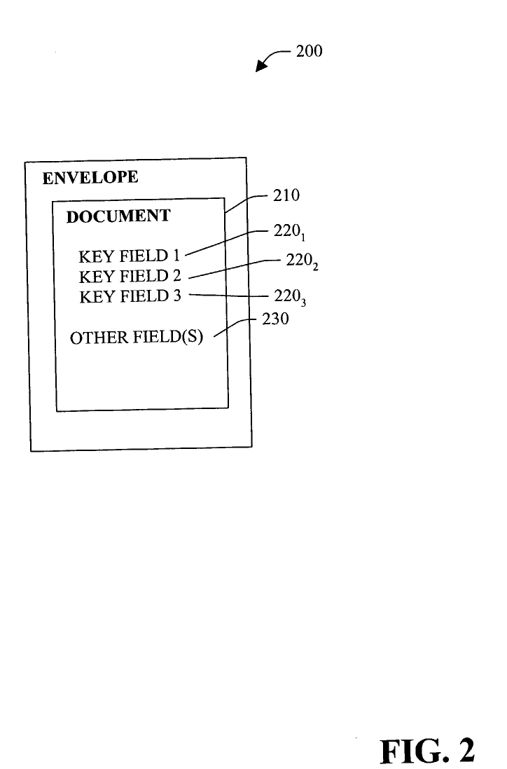

Turning briefly to FIG. 2, an envelope 200 in accordance with an aspect of the present invention is illustrated. The envelope 200 includes a business document 210 that has key field(s) 220 and, optionally, other field(s) 230. The business document 210 is encapsulated in the enveloped 200. The business document 210 can be uniquely identified by the set of key field(s) 220.

The envelope 200 tracks information about the document (e.g. metadata). The envelope 200 can track log of action(s), for example, creation date and/or time, creation actor, next modified date and/or time, next modified actor, last modified date and/or time, and/or, last modified actor.

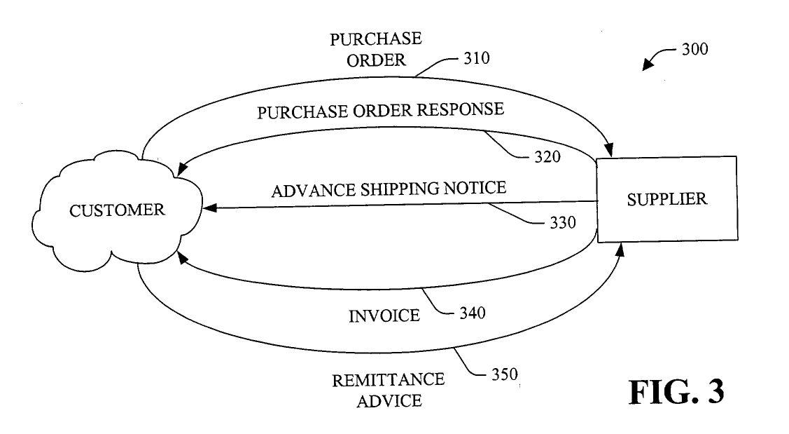

The system 100 can be employed, for example, with regard to an order-to-cash scenario. The order-to-cash scenario is a common scenario in manufacturing, distribution and/or retail companies. An exemplary order-to-cash scenario 300 in accordance with an aspect of the present invention are illustrated in FIG. 3. The order-to-cash scenario 300 illustrates the flow of documents between a customer 310 and a supplier 320.

The event flow sequence for the exemplary order-to-cash scenario 300 is as follows. First, the customer 310 sends a Purchase Order 330 for an item to the supplier 320. The supplier 320 acknowledges receipt of the Purchase Order 330 with a Purchase Order Response 340. The supplier 330 then builds and fulfills the request for the item. On shipping the item, an advance shipping notification document 350 is sent to the customer 310. Thereafter, the supplier 320 submits an invoice document 360 to the customer 310. The customer 310, on acceptance of the shipment then sends a remittance document 370 with the payment information. It is to be appreciated that the scenario 300 can have exception handling step(s) which have not been described for the sake of brevity.

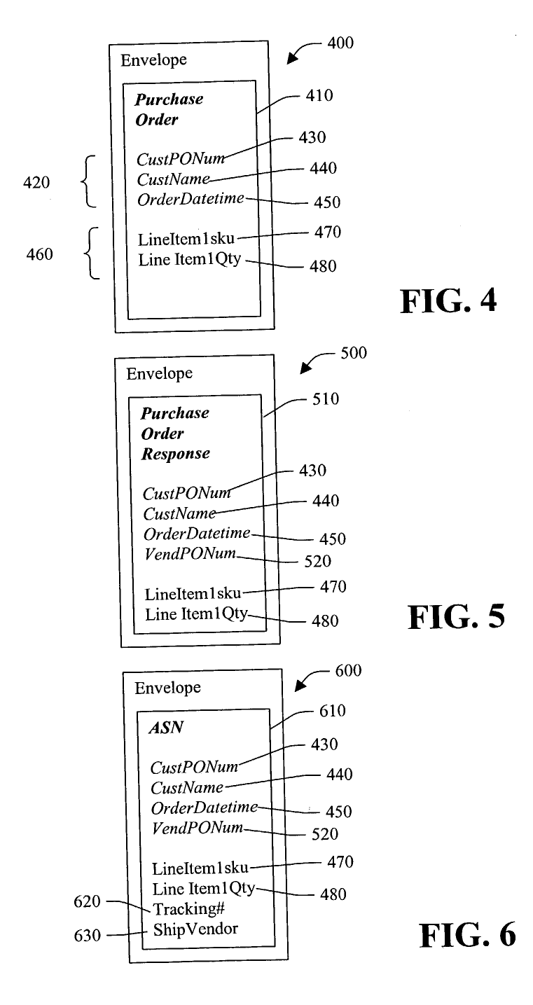

Turning to FIG. 4, an exemplary purchase order envelope 400 in accordance with an aspect of the present invention is illustrated. The envelope 400 includes a purchase order 410. In an order-to-cash scenario (e.g., order-to-cash scenario 300), the purchase order 410 can serve as the root node for the scenario (e.g., defined at design-time). Key field(s) 420, for example, customer purchase order number 430, customer name 440 and/or order datetime 450 can serve as a unique identifier for the scenario. Optionally, the purchase order 410 can further include other field(s) 460, for example, LineItem 1 sku 470 and/or Line Item 1 Qty 480.

Referring briefly to FIG. 5, an exemplary purchase order response envelope 500 in accordance with an aspect of the present invention is illustrated. The envelope 500 includes a purchase order response 510. The purchase order response 510 can include key field(s), for example, customer purchase order number 430, customer name 440, order datetime 440 and/or VenPONum 520. The purchase order response 510 can further include other field(s), for example, LineItem 1 sku 470 and/or Line Item 1 Qty 480.

Next, turning to FIG. 6, an exemplary advance shipping notification envelope 600 in accordance with an aspect of the present invention is illustrated. The envelope 600 includes an advance shipping notice 610. The advance shipping notice 610 can include key field(s). Additionally, the advance shipping notice 610 can include other field(s), for example, LineItem 1 sku 470, Line Item 1 Qty 480, Tracking# 620 and/or ShipVendor 630.

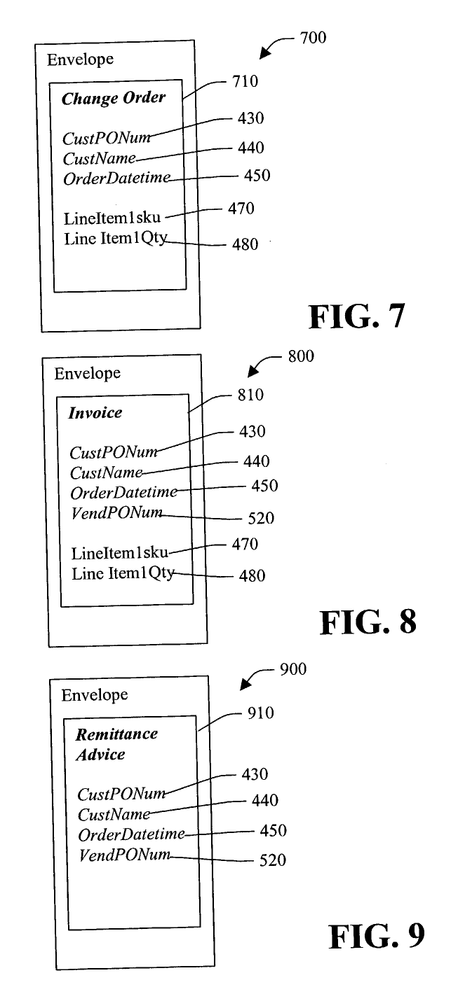

Referring to FIG. 7, an exemplary change order envelope 700 in accordance with an aspect of the present invention is illustrated. The envelope 700 includes a change order 710. The change order 710 can include key field(s) and, optionally, other field(s).

Briefly turning to FIG. 8, an exemplary invoice envelope 800 in accordance with an aspect of the present invention is illustrated. The envelope 800 includes an invoice 810. The invoice 810 can include key field(s) and, optionally other field(s).

Next, referring to FIG. 9, an exemplary remittance advice envelope 900 in accordance with an aspect of the present invention is illustrated. The envelope 900 includes a remittance advice 910. The remittance advice 910 can include key field(s) and, optionally other field(s).

FIGS. 4 through 9 illustrates exemplary business document envelopes in accordance with aspects of the present invention. The purchase order envelope 410, the purchase order response envelope 510, the advance shipping notification envelope 610, the change order envelope 710, the invoice envelope 810 and/or the remittance advice envelope 910 can be employed as part of the order-to-cash scenario 300. One or more of the key field(s) 420 are utilized as a unique identifier for a particular business scenario. For example, for a retailer executing multiple order-to-cash scenarios per day (e.g., thousands), the order-to-cash scenario 300 can be described as follows.

First, initiation of a business scenario occurs when a new top level transaction is created that instantiates the business scenario. In this example, it is the arrival of the purchase order 410 document at the business entity (e.g., root node). Thereafter, at any given point in time, a user of the system (e.g., an interested individual in an entity) can call up specific executing instance(s) of the business scenario 300 and be able to visualize the state of the scenario (e.g., essentially viewing it from a business user's standpoint).

In one example, the user is able to visually inspect a specific document in the business scenario execution instance (e.g., the document converted into an appropriate format for the user to view).

In another example, a document store does not store information associated with visualization of the documents. For example, a document is retrieved, and associated with an XSLT to visualize it (e.g., in HTML). Thus, separation of business logic from the presentation is facilitated.

For example, with regard to customer service, a customer service representative can receive an inquiry (e.g., via telephone) call from a customer, inquiring about an order that the customer placed. The customer service representative can obtain the customer's purchase order number and perform a search based on the purchase order number. The system can provide a set of organized documents that show the transactions that have happened since the time the purchase was received. For example, the customer service representative can obtain information associated with the state of the purchase order.

At design time, a developer can designate a business document as a root node (e.g., top level scenario transaction document) and/or as leaf node document. Top-level documents are associated with the initiation of the execution of an instance of a business scenario. Leaf-level node document(s) are created as a future step in the execution of a business scenario. For example, the designation can be implemented by way of specialized annotation to the XSD doc definition. A doc definition can be employed to designate a document as a root-node by way of annotation to the XSD of the document. Further, key field(s) within document(s) (root or leaf) can be annotated decoration of the corresponding XSDs.

In one example, in order to avoid creation of an additional system of record(s), no relational schema is recreated in the business scenario e-business system. Documents are stored in their native format (e.g., XML). The key field(s) are stored in relational tables so they can be indexed and related. The key field(s) are used for searching for matching top level transaction sets. They are also used for stringing together a set of related documents that form the execution thread of a business scenario.

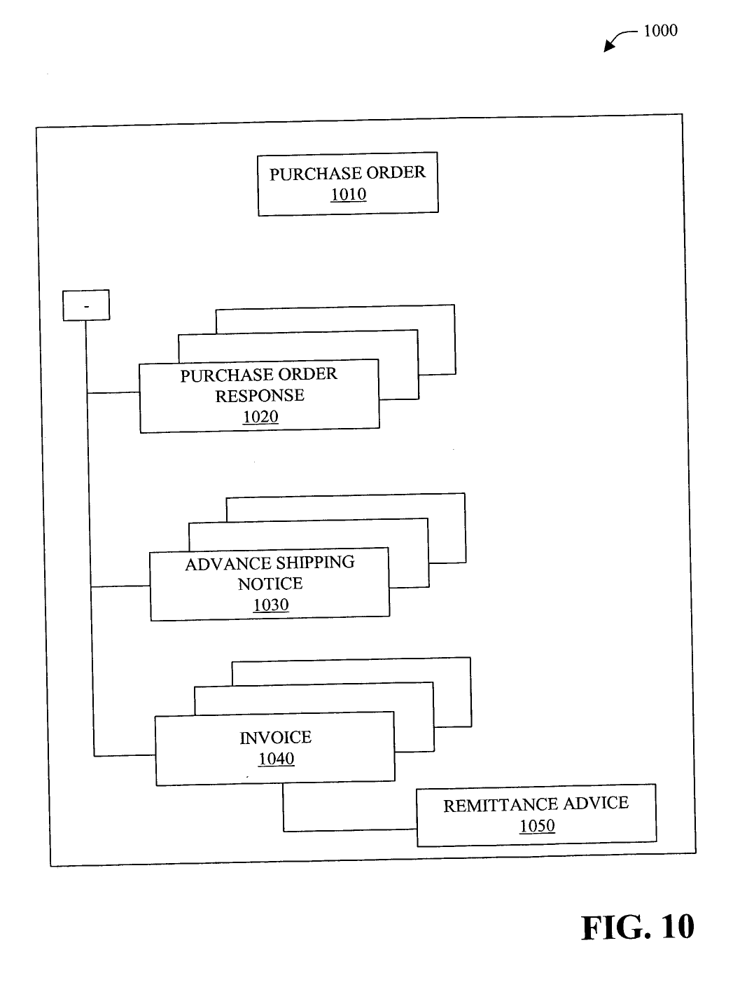

Next, referring to FIG. 10, an exemplary user interface 1000 in accordance with an aspect of the present invention is illustrated. The user interface 1000 includes a key field identification region 1010, a first correlation field 1020, a second correlation field 1030, a third correlation field 1040, and, a fourth correlation field 1050.

In the example of FIG. 10, the key field identification region 1010 is populated with a purchase order, the first correlation field 1020 identifies corresponding purchase order responses, the second correlation field 1030 identifies corresponding advance shipping notifications, the third correlation field 1040 identifies corresponding invoices, and, the fourth correlation field 1050 identifies remittance advice(s) associated with invoice(s).

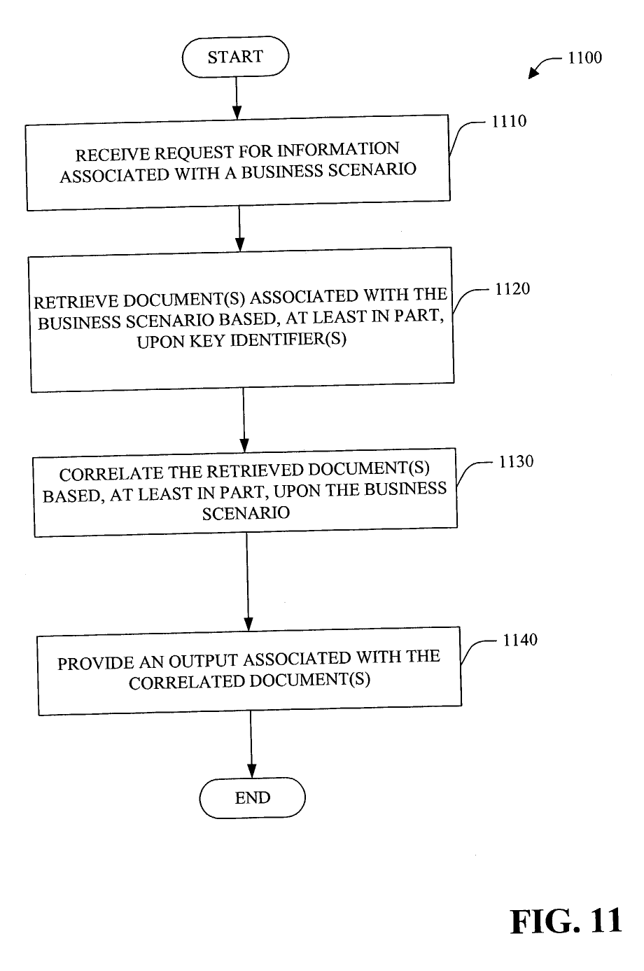

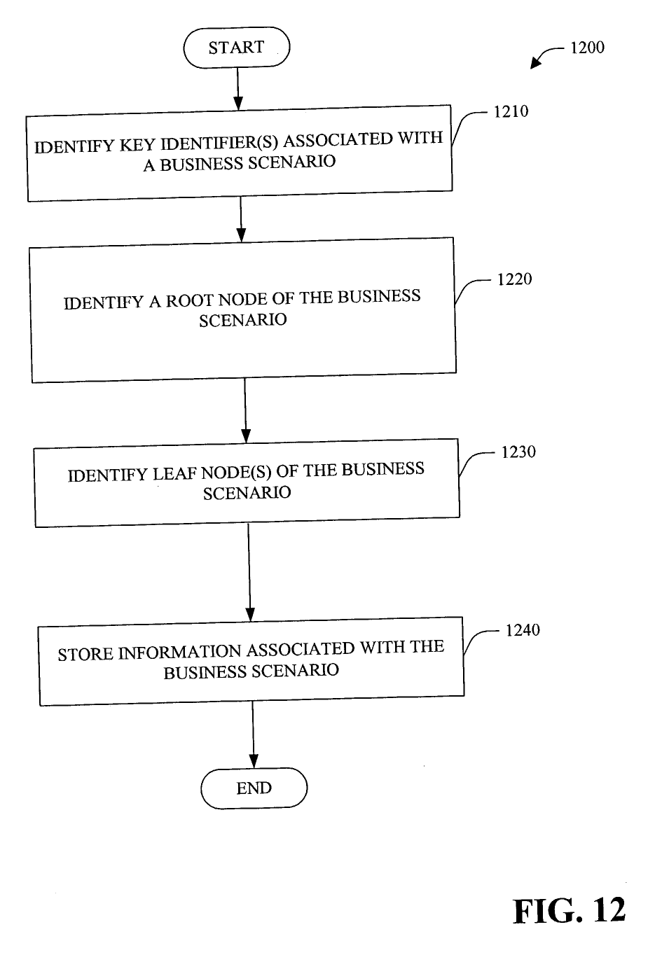

Turning briefly to FIGS. 11 and 12, methodologies that may be implemented in accordance with the present invention are illustrated. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

The invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Referring to FIG. 11, a method of correlating e-business information 1100 in accordance with an aspect of the present invention is illustrated. At 1110, a request for information associated with a business scenario is received. At 1120, document(s) associated with the business scenario are retrieved based, at least in part, upon key identifier(s). At 1130, the retrieved document(s) are correlated based, at least in part, upon the business scenario. At 1140, an output associated with the correlated document(s) is provided.

Turning to FIG. 12, a method of generating a business scenario for e-business 1200 in accordance with an aspect of the present invention is illustrated. At 1210, key identifier(s) associated with a business scenario are identified. At 1220, a root node of the business scenario is identified. At 1230, leaf node(s) of the business scenario are identified. At 1240, information associated with the business scenario is stored.

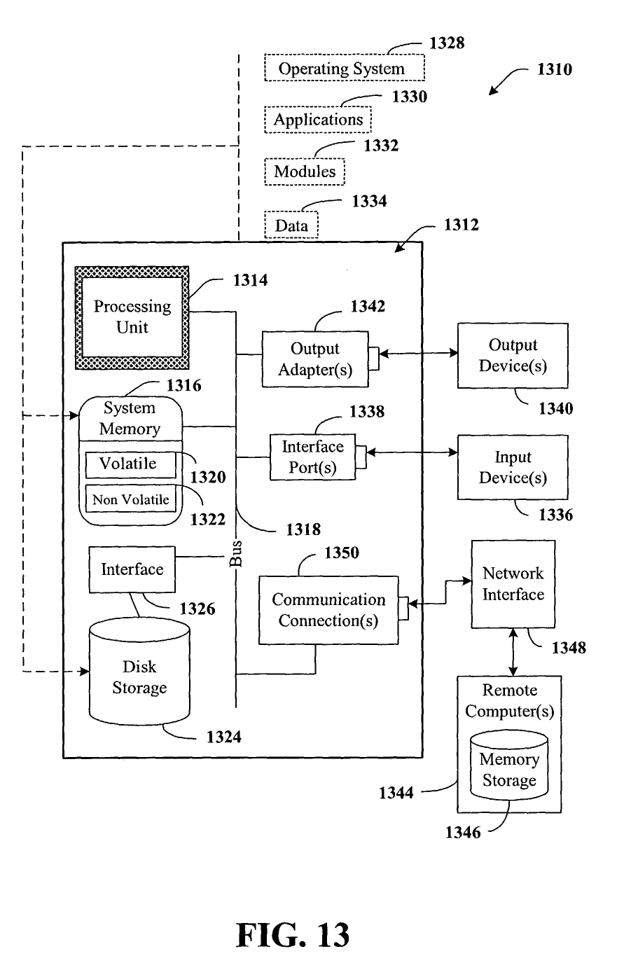

In order to provide additional context for various aspects of the present invention, FIG. 13 and the following discussion are intended to provide a brief, general description of a suitable operating environment 1310 in which various aspects of the present invention may be implemented. While the invention is described in the general context of computer-executable instructions, such as program modules, executed by one or more computers or other devices, those skilled in the art will recognize that the invention can also be implemented in combination with other program modules and/or as a combination of hardware and software. Generally, however, program modules include routines, programs, objects, components, data structures, etc. that perform particular tasks or implement particular data types. The operating environment 1310 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 13, an exemplary environment 1310 for implementing various aspects of the invention includes a computer 1312. The computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PC), Universal Serial Bus (USB), Advanced Graphics Port (AGP), Personal Computer Memory Card International Association bus (PCMCIA), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable ROM (EEPROM), or flash memory. Volatile memory 1320 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1312 also includes removable/nonremovable, volatile/nonvolatile computer storage media. FIG. 13 illustrates, for example a disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used such as interface 1326.

It is to be appreciated that FIG. 13 describes software that acts as an intermediary between users and the basic computer resources described in suitable operating environment 1310. Such software includes an operating system 1328. Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. It is to be appreciated that the present invention can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312, and to output information from computer 1312 to an output device 1340. Output adapter 1342 is provided to illustrate that there are some output devices 1340 like monitors, speakers, and printers among other output devices 1340 that require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An e-business correlation system comprising:
a retrieval component that retrieves business documents from a plurality of data stored based, at least in part, upon a key field; and,
a business model component that correlates the retrieved business documents based, at least in part, upon a business scenario, and provides an output based, at least in part, upon the correlated business documents.

2. The system of claim 1, business documents comprising at least one of a purchase order, a purchase order response, an advance shipping notification, an invoice and a remittance advice.

3. The system of claim 1, wherein the business scenario defines a root node and at least one leaf node.

4. The system of claim 1, wherein the retrieval component further retrieves business documents from the plurality of data stored based, at least in part, upon at least two key fields, the key fields forming a unique identifier for business documents associated with the business scenario.

5. The system of claim 1, at least one of the data stores storing envelopes, an envelope storing metadata associated with a business document.

6. The system of claim 5, the envelope facilitating tracking of at least one of creation date, creation time, creation actor, next modified date, next modified time, next modified actor, last modified date, last modified time and last modified actor.

7. The system of claim 1, the business scenario comprising an order-to-cash scenario or a customer service scenario.

8. The system of claim 1, at least some of the business documents being stored in XML format.

9. A method of correlating e-business information comprising:
retrieving business documents associated with a business scenario based, at least in part, upon a key identifier; and,
correlating the retrieved business documents based, at least in part, upon the business scenario.

10. The method of claim 9, further comprising at least one of the following steps:
receiving a request for information associated with the business scenario; and,
providing an output associated with the correlated business documents.

11. A computer readable medium having stored thereon computer executable instructions for carrying out the method of claim 9.

12. The method of claim 9, the business documents being XML-based.

13. A method of generating a business scenario for e-business comprising:
identifying a key identifier associated with the business scenario;
identifying a root node of the business scenario; and,
identifying a leaf node of the business scenario.

14. The method of claim 13 further comprising storing information associated with the business scenario.

15. A computer readable medium having stored thereon computer executable instructions for carrying out the method of claim 13.

16. An e-business correlation user interface comprising:
a key field identification region that displays a key field associated with a business scenario; and,
at least one correlation field that displays business documents associated with the business scenario.

17. A data packet transmitted between two or more computer components that facilitates e-business correlation, the data packet comprising:
an envelope comprising a business document having at least one key field, the envelope having metadata associated with the business document.

18. A data packet transmitted between two or more computer components that facilitates e-business correlation, the data packet comprising:
information associated with a plurality of correlated business documents, the information being based, at least in part, upon business documents retrieved from a plurality of data stores based, at least in part, upon a key identifier, correlation of the business documents being based, at least in part, upon a business scenario.

19. A computer readable medium storing computer executable components of an e-business correlation system, comprising:
a retrieval component that retrieves business documents from a plurality of data stores based, at least in part, upon a key field; and,
a business model component that correlates the retrieved business documents based, at least in part, upon a business scenario, and provides an output based, at least in part, upon the correlated business documents.

20. An e-business correlation system comprising:
means for retrieving business documents from a plurality of data stores based, at least in part, upon a key field;
means for correlating the retrieved business documents based, at least in part, upon a business scenario; and,
means for providing an output based, at least in part, upon the correlated business documents.
